(19) United States
(12) Patent Application Publication
(10) Pub. No.: US 2012/0102419 A1
(43) Pub. Date: Apr. 26, 2012

(54) REPRESENTING DATA THROUGH A GRAPHICAL OBJECT

(75) Inventors: Vijay Mital, Kirkland, WA (US); Darryl Ellis Rubin, Duvall, WA (US); David G. Green, Redmond, WA (US); Ahmad Nizam Anuar, Snoqualmie, WA (US); Suraj T. Poozhiyil, Redmond, WA (US); Jeremy William John Newton-Smith, Lake Forest Park, WA (US)

(73) Assignee: Microsoft Corporation, Redmond, WA (US)

(21) Appl. No.: 12/950,458

(22) Filed: Nov. 19, 2010

Related U.S. Application Data
(60) Provisional application No. 61/405,939, filed on Oct. 22, 2010.

(51) Int. Cl. G06F 3/048

(52) U.S. Cl. 715/765; 715/764

(57) ABSTRACT

Aspects discussed relate to creating a presentation of data through an arbitrary graphical object that has the capacity to visually represent data. Based on parameters of the visual characteristics and/or the data set, dimensions of data may be bound to appropriate visual characteristics of the graphical object to render a data visual of the dimensions of data through the graphical object. Visual characteristics and/or dimensions of data may additionally be subject to applied filters and/or constraints. When filters and/or constraints are applied resulting in any modification of the graphical object and/or dimensions of data, a subsequent data visual may be rendered. For some cases, a user interface may enable renderings of data visuals to occur dynamically upon modification of visual characteristics and/or dimensions of data.

### BACKGROUND

People today are continuously exposed to large amounts of information, particularly in the form of quantitative data. It is often useful for such data to be presented in an intuitive manner. For example, a person tasked with the responsibility to give a presentation of a quantitative data set to others may find it useful to convey the information through a visual representation, such as a pie chart or bar/line graph. Thus, by presenting data using a visual representation, the data can be more easily explained than if merely numbers were presented.

It has become standard for users to operate computers having processors run with suitable software to gather, organize, manipulate and present data. Spreadsheets, for example, are commonly used to view and analyze large amounts of data. Portions of a data set contained within a spreadsheet may be selected in a manner to create a graphical representation of the data, such as in the form of a chart or graph. For example, data may be input from a spreadsheet into a line graph in a straight forward manner, so that trends along the function set forth by the line graph and determined by the data set can be easily visualized. Data plotted out by the line graph may also be manipulated, in turn, by altering features of the line graph and/or dimensions of the data set itself.

### SUMMARY

Aspects discussed relate to creating a visual of data through an arbitrary graphical object. Graphical objects may be created via any suitable graphical manipulation tool to have visual characteristics that have the capacity to visually represent data. Dimensions of data may be mapped to corresponding visual characteristics of a graphical object such that values of the data influence the appearance of those visual characteristic(s) of the graphical object.

The ability for visual characteristics of a graphical object to represent data visually may depend on parameters associated with the visual characteristic(s) (e.g., through appropriate metadata). Such parameters of data visualization may be inferred through an analysis of the graphical object and/or the data to be presented. Parameters of data visualization may also be explicitly defined through a graphical manipulation tool.

In some cases, a number of graphical objects may be available to visually represent dimensions of data where a computing device may propose one or more of the graphical objects to a user which have characteristics suitable for dimensions in the data set to be mapped. A user may select a graphical object for suitable visualization. A user may also choose an appropriate data set for visual representation through the selected graphical object.

Visual characteristics and/or data of a data visual may also be subject to one or more filters and/or constraints, resulting in a modified rendering of the data visual based on the applied filter(s) and/or constraint(s). In some embodiments, alterations or modifications of a data visual rendering occur dynamically through a suitable user interface.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a system in accordance with some embodiments;

FIG. 2 is a flow chart of a method of operating a system for displaying data through a graphical object according to some embodiments in a format that aids a user to visualize the data;

FIG. 3 is a flow chart of an embodiment for displaying data represented as a graphical object with variably visual characteristics;

FIG. 4 is an illustrative example of a user interface through which a user is able to visualize data through a graphical object;

FIG. 5 is a representative illustration of the user interface of FIG. 4 in a state in which a graphical object is being chosen;

FIG. 6 is a representative illustration of the user interface of FIG. 5 where the graphical object is presented and data to be displayed is being chosen;

FIG. 7 is a representative illustration of the user interface of FIG. 6 where dimensions of a data set are presented;

FIG. 8 is a representative illustration of the user interface of FIG. 7 where a type of visualization of the graphical object is specified;

FIG. 9 is a representative illustration of the user interface of FIG. 8 in which visual characteristics of the graphical object are presented;

FIG. 10 is a representative illustration of the user interface of FIG. 9 where visual characteristics of the graphical object are further presented;

FIG. 11 is a representative illustration of the user interface of FIG. 10 where a filter applied to a dimension of the data set influences the appearance of a visual characteristic of the graphical object;

FIG. 12 is a representative illustration of the user interface of FIG. 11 in which the visual characteristic of the graphical object is subject to the filter; and

FIG. 13 is an illustration of an example of a general user interface for displaying data through a graphical object.

### DETAILED DESCRIPTION

The inventors have recognized and appreciated the value of representing sets of data through graphical object(s) created by graphics designers independently from the data. A graphical object having a number of visual characteristics may be created via any suitable graphical manipulation tool where visual characteristics of the graphical object may also have the capacity to visually represent data. For example, a graphical object that is formed as a dumbbell may have visual characteristics such as a bar and weights located on opposite sides of the bar. The size of the weights of the dumbbell, for example, may increase when the range of data represented by the weights of the dumbbell is broadened.

A graphical object may represent a data set by mapping a dimension of the data set to visual characteristics such that values in that dimension may alter the appearance of the characteristics. Accordingly, dimensions of data may be mapped to particular visual characteristics of a graphical object such that values of the data set alter the appearance of the visual characteristics based on parameters of the relationship formed between the visual characteristic(s) and the dimension(s) of data.

Through a traditional approach, a data set may be entered into a spreadsheet and displayed through a line graph. In some instances, a line graph may be insufficient to effectively represent other more complex sets of data. However, aspects described herein provide for the ability to use any arbitrary visual object as a foundation for which aspects of a data set may be imported into characteristics of the graphical object for suitable visualization of the data. Indeed, certain graphical objects may be well-tailored to represent certain sets of data. Further, visualizing data through separately created graphical objects may provide for more interesting presentation of the data while not being limited to conventional approaches.

In an example that will be described in more detail below, it may be desirable for data relating to sales in the past year of a company to be suitably displayed. This data may have multiple dimensions such as sales per quarter and sales events. Sales information for each quarter could be displayed, for example, through a conventional bar graph that depicts the amount of sales at the end of each quarter. The occurrence of the sales events also could be presented through a conventional graph. However, such a presentation of the data, using separate graphs, may be cumbersome for a user or not visually interesting. As a solution, it may be beneficial for both sets of data to be presented simultaneously together, as one visual object that may have interesting visual characteristics or multiple characteristics that can be varied to represent values of the data in multiple dimensions. Indeed, embodiments presented herein provide for the ability to visually present the data in an intuitive manner using a graphical object having characteristics that enable dimensions of data to be presented through the graphical object.

Data may be presented through an appropriate graphical object based on the capacity for the graphical object to represent the data. Such capacity may be determined by a number and type of visual characteristics of the graphical object with associated parameters that can be varied to represent the data. A data set may be represented by such a graphical object if each dimension of the data to be displayed can be matched to a parameter of a suitable type. For example, some dimensions of a data set may take on values that are continuous. A percentage increase in sales, for example, may take on any value. To visually represent percentage sales increases, that dimension of the data set may be mapped to a visual characteristic that has a parameter that may have a value that similarly may be varied continuously, though possibly subject to constraints such as constraints on a maximum or minimum value. For example, a length of an object or density of shading are examples of visual characteristics that may be varied continuously. Other dimensions of data may be of other types, such as being represented by a set of enumerable values, being a range of values, etc. Visual characteristics that are of matching types may be selected to represent these dimensions.

These visual characteristics may be determined in any suitable way. In some embodiments, parameters of data visualization for a graphical object may be inferred by an analysis of the visual characteristics of the graphical object. For example, a graphical object may have visual characteristics (e.g., shape) that provide for parameters (e.g., length of the boundary of the shape) which may or may not be applicable to certain types of data. In some embodiments, a developer or creator of a graphical object may explicitly define parameters of the graphical object according to certain visual characteristics of the graphical object through which certain types of data may be displayed.

In some embodiments, a system has access to a data set and a graphical object. The system analyzes the graphical object and the data set to determine whether visual characteristics of the graphical object are compatible for mapping of dimensions in the data set to the visual characteristics, resulting in a visualization of the data through the graphical object. In cases where multiple graphical objects are available, the system may propose to a user one or more of the graphical objects which have characteristics that are suitable for representing each dimension of the data set that the user has indicated are to be displayed. The user may then select a suitable graphical object on to which the data set is to be mapped and the system may subsequently generate a visualization of the data.

Once a data visual is presented (e.g., on a display of a user interface) where dimensions of a data set are bound to visual characteristics of a corresponding graphical object, a user may interact with portions of the graphical object and/or the data set through a graphical interface and provide modifications to the data visual dynamically.

Thus, embodiments described herein provide an ability for dimensions of data to be mapped to arbitrary graphical objects for the dimensions of data to be suitably represented. Graphical objects may be created through any suitable graphical manipulation tool (e.g., MICROSOFT EXPRESSION® Studio, MAXON Cinema 4D). Graphical objects may include information (e.g., metadata) that sets forth the parameters through which dimensions of data may be bound to the graphical objects (i.e., to visual characteristics). In an embodiment, a software tool analyzes a graphical object and produces metadata that describes the extent to which data may be bound to various visual characteristics of the graphical object. In another embodiment, as part of the creation process of the graphical object, a user expressly defines parameters (e.g., described by metadata) of visual characteristics in the graphical object that may be mapped to certain types of data. In some embodiments, a software tool analyzes a data set, which may or may not have appropriate metadata to determine a number and type of dimensions that could be displayed, and determines graphical objects that would be suitable to represent the data set. Such a toll may receive user input selecting dimensions of a data set to be displayed.

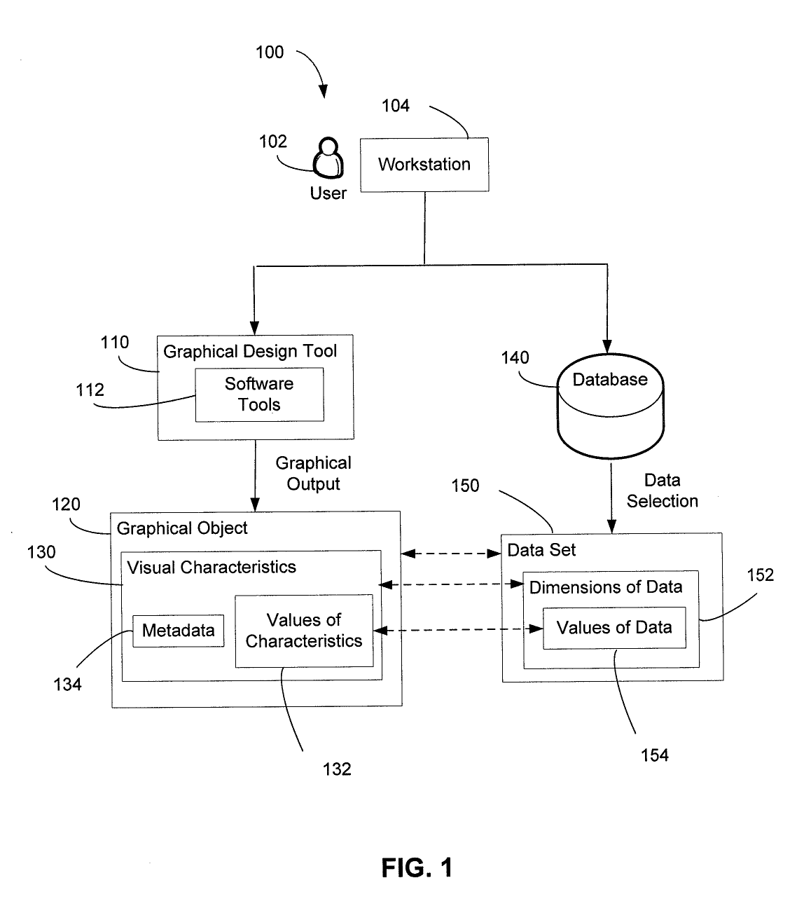

FIG. 1 is a block diagram illustrating a system 100 in which some embodiments of the invention may be practiced. System 100 may include one or more computing devices with which a user may interact. A computing device may be any suitable computing device, such as a desktop computer, a laptop computer, a mobile phone, or a PDA. A computing device may operate under any suitable computing architecture, and include any suitable operating system, such as variants of the WINDOWS® Operating System developed by MICROSOFT® Corporation.

A computing device may have the capability to communicate over any suitable wired or wireless communications medium to a server. The communication between a computing device and a server may be over computer network(s), which may be any suitable number or type of telecommunications networks, such as the Internet, a corporate intranet, or cellular networks. A server may be implemented using any suitable computing architecture, and may configured with any suitable operating system, such as variants of the WINDOWS® Operating System developed by MICROSOFT® Corporation.

As shown in FIG. 1, embodiments of the system 100 may include a user 102 on a workstation 104 having access to a graphical design tool 110 and a database 140. The graphical design tool 110 incorporates a number of software tools 112. A user 102 may employ the graphical design tool 110 to create an output, resulting in a graphical object 120. The graphical object includes visual characteristics 130 having values 132 that describe the visual characteristics according to any suitable software environment. The graphical object may also include metadata 134 that contains information related to aspects of the visual characteristics and/or values, for example, relating to how one or more of the visual characteristics may represent data.

The system 100 may also include a database 140 where a user may select a data set 150 from the database. The data set 150 includes dimensions of data 152 which, in turn, include values of data 154. In embodiments described herein, a suitable mapping of the data set 150 with the graphical object 120 may occur. For example, dimensions of data 152 of the data set 150 may map to suitable visual characteristics 130 of the graphical object 120. Similarly, values of data 154 within the dimensions of data 152 may map to corresponding values 132 of visual characteristics 130, in accordance with parameters set forth by the metadata 134. It should be appreciated that a graphical design tool 110 and a database 140 may be stored and/or accessed on the same or separate computing devices.

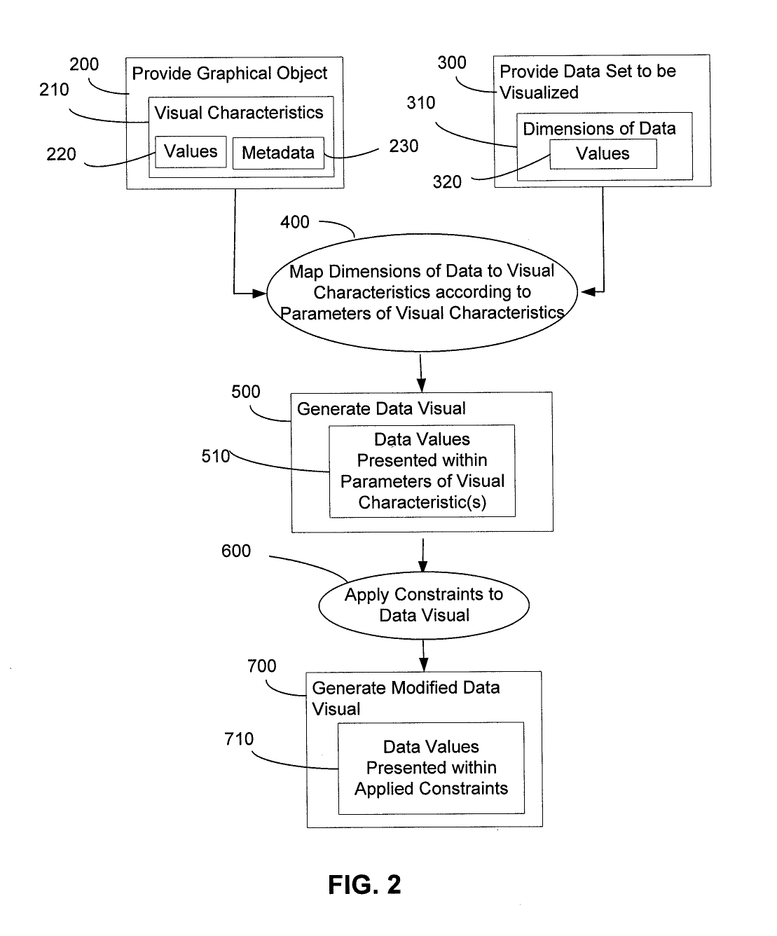

In some embodiments, once a user 102 has access to one or more appropriate graphical objects and data sets, the user initiates a set of commands on a computing device 105 having an appropriate set of executable instructions. Execution of these instructions may result in the system displaying a visualization of dimensions within a data set, in accordance with the flow chart of FIG. 2. In step 200, a graphical object is provided having a number of visual characteristics 210 which may or may not be subject to data visualization on the computing device. The visual characteristics may have values 220 according to parameters defined by metadata 230 of the visual characteristics. The graphical object may be selected by a user from a library, or a user may define visual characteristics using a graphical design program. In some cases, a computing device in a system may select matching values and types of visual characteristics according to the type of dimensions of a data set. In step 300, a computing device also has access to a data set to be presented, the data set having a number of dimensions of data 310 having values 320.

In step 400, dimensions of data 310 are mapped to visual characteristics. The mapping may relate each dimension to be represented to a visual characteristic. Values of the data in each mapped dimension may then be used to define a value of a parameter that controls a mapped visual characteristic. The values of the dimension may directly set the value of the corresponding parameter of the visual characteristic. Though, in some embodiments, the mapping may include a transformation, such as scaling the values of the data set, constraining the values, associating values with range or otherwise manipulating the data. To aid in such a mapping, a graphical object may contain metadata that identifies parameters to which data can be mapped. As discussed above, for some cases, such parameters may be implied by a suitable analysis of the graphical object where the parameters are applied to the visual characteristics. Or, parameters of the visual characteristics may be explicitly defined by a developer or user of the graphical object.

For the same graphical object, it may be possible for different parameters to be defined for how values of the visual characteristics are mapped to values of the dimensions of data. That is, a user may specify what parameters corresponding to one or more visual characteristics of a single graphical object to use. Accordingly, a particular set of parameters may be selected for a graphical object to represent one dimension of a data set, while a different set of parameters may be selected for the same graphical object to represent a different dimension of the data set. Such selection of parameters for a graphical object may be performed automatically or manually.

In step 500, a data visual is generated by the system that presents dimensions of data through and within bounds of the visual characteristics in accordance with corresponding parameters. Accordingly, based on the mapping, the system obtains data values from a dimension of a data set and computes the value of a parameter that controls the appearance of a visual characteristic. Once an appropriate visualization of data is generated, in step 600, the system may receive user input to apply one or more suitable constraints and/or filters to the visualization. Based on the applied constraint(s) and/or filter(s), in step 700, a modified data visual may be generated 710 by the system.

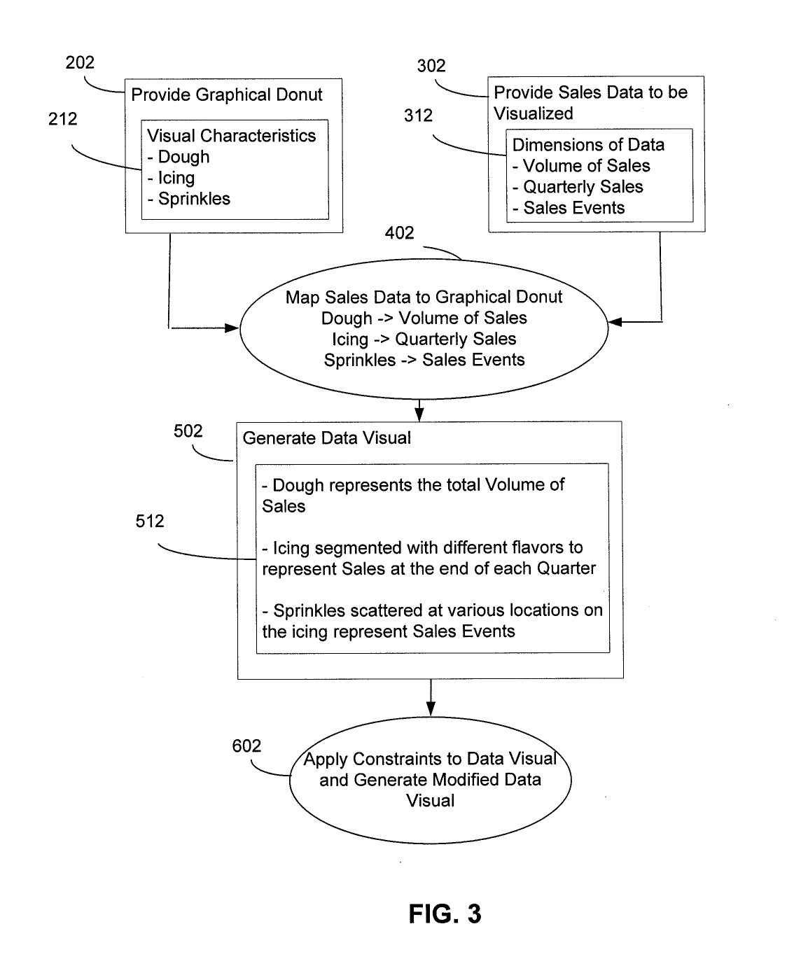

As an example of such a process, a flow chart of a representative embodiment for the system to produce a visualization of a data set through a graphical object is shown in FIG. 3. Specifically, data regarding sales revenues reported by a company over the past year is presented through a graphical donut. In step 202, a graphical donut is presented to a user as a viable graphical object for visualizing data. The graphical donut has visual characteristics 212 for supporting generating a data visual, including the dough of the donut, the color of the icing and the number of sprinkles. In step 302, it is desired for sales data presented to a user to be represented through the graphical donut. Sales data include dimensions of data 312, such as the total volume of sales reported over the past year, quarterly sales reported and sales events.

In step 402, sales data are mapped to the graphical donut according to parameters of the graphical donut that define how the visual characteristics support mapping of the data. For example, by the system receiving an appropriate user input, the total volume of sales reported can be mapped to the dough of the donut; quarterly sales reported can be mapped to the icing of the donut; and sales events can be mapped to sprinkles of the donut.

In step 502, a data visual is generated by the system, where the dough of the graphical donut represents the total volume of sales reported; the icing is partitioned around the donut into different colors representing the sales reported at the end of each quarter; and individual sprinkles disposed on the icing represent particular sales events that happened throughout the year. In some cases, the location of sprinkles disposed on the icing may be random. Or, the location of the sprinkles may be tied to a different dimension, for example, a number of sprinkles corresponding to specific sales events may be displayed in a segment of icing that corresponds to a particular quarter when the sales event represented by the sprinkles occurred.

In step 602, after the data visualization is generated and presented to the user, suitable constraints and/or filters may be applied to various aspects of the data visual, for example, modification of one or more visual characteristics or the data itself. Once added constraints and/or filters are applied to the visualization, a modified data visualization is generated where dimensions of data and/or visual characteristics fall within the applied constraint(s) and/or filter(s).

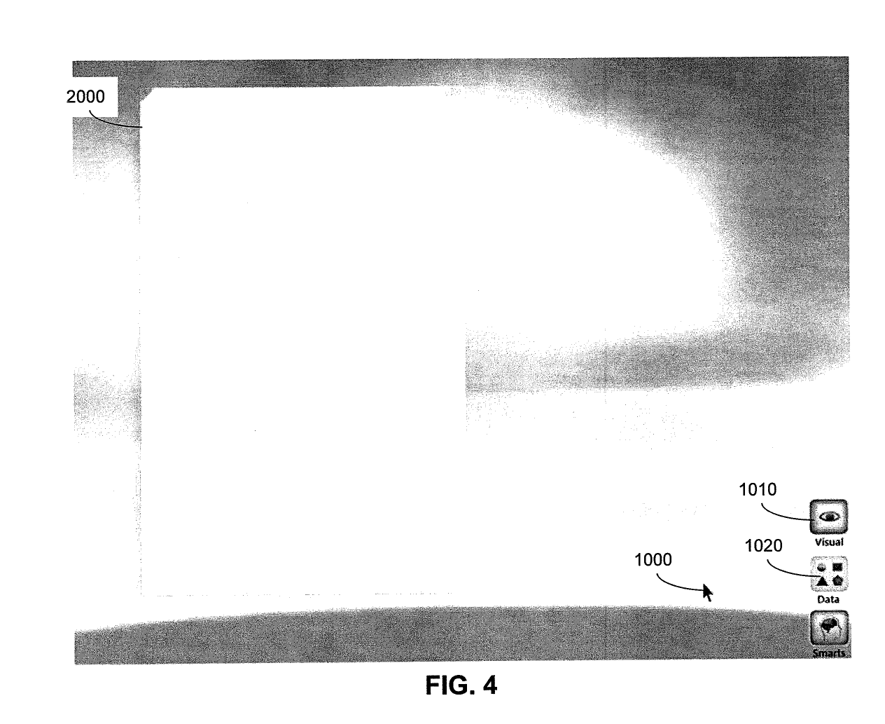

FIGS. 4-12, now described, illustrate a representative embodiment where a user interface of a data visualization system is manipulated to produce a data visual in accordance with aspects of the flow diagram described in FIG. 3. It should be appreciated that the embodiment described does not serve as a limitation to aspects of the invention. In FIG. 4, a user has the ability to choose, with pointer 1000, a number of icons on the user interface. “Visual” icon 1010 permits the user to select from a number of graphical objects through which data may be displayed. “Data” icon 1020 allows the user to choose a data set to be displayed through the selected graphical object. The user interface also provides a canvas 2000 on which visualizations of data may be displayed.

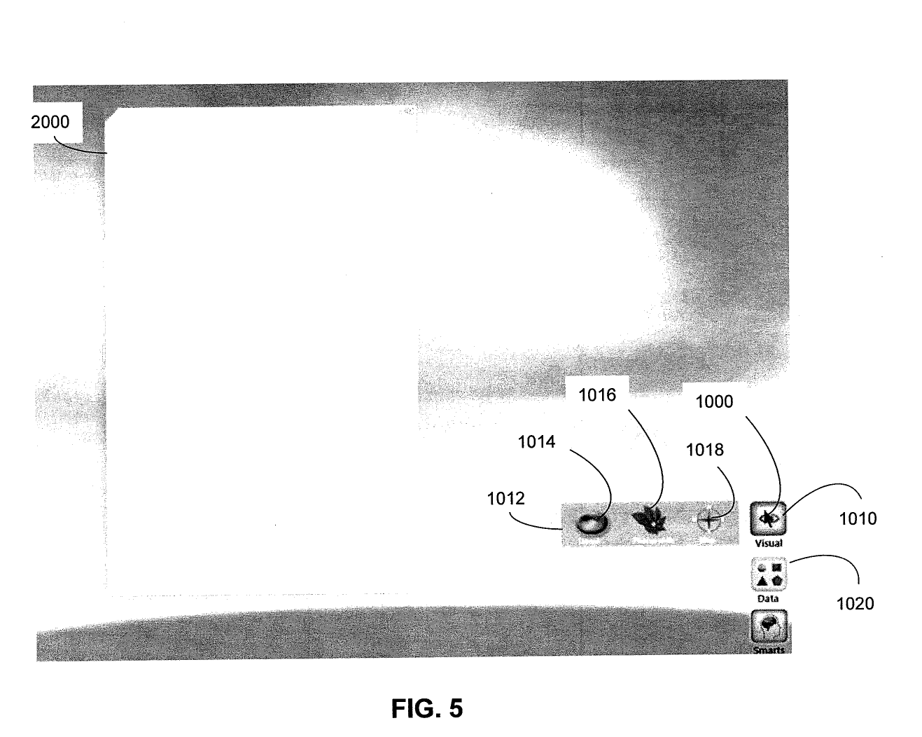

In FIG. 5, a user manipulates pointer 1000 to choose “Visual” icon 1010, triggering the appearance of an interface 1012 through which a user may select graphical objects. The interface 1012 includes three different graphical objects that the user may choose to represent the data as a visualization. That is, the user may select one of a graphical donut 1014, a graphical photosynthetic object 1016 or a graphical map 1018 for display of data to aid a user visualize the data. In this example, though without limitation, the user chooses graphical donut 1014 as the object through which data visualization is to occur. Indeed, any of the graphical objects depicted in selection box 1012 could have suitably been chosen for displaying data.

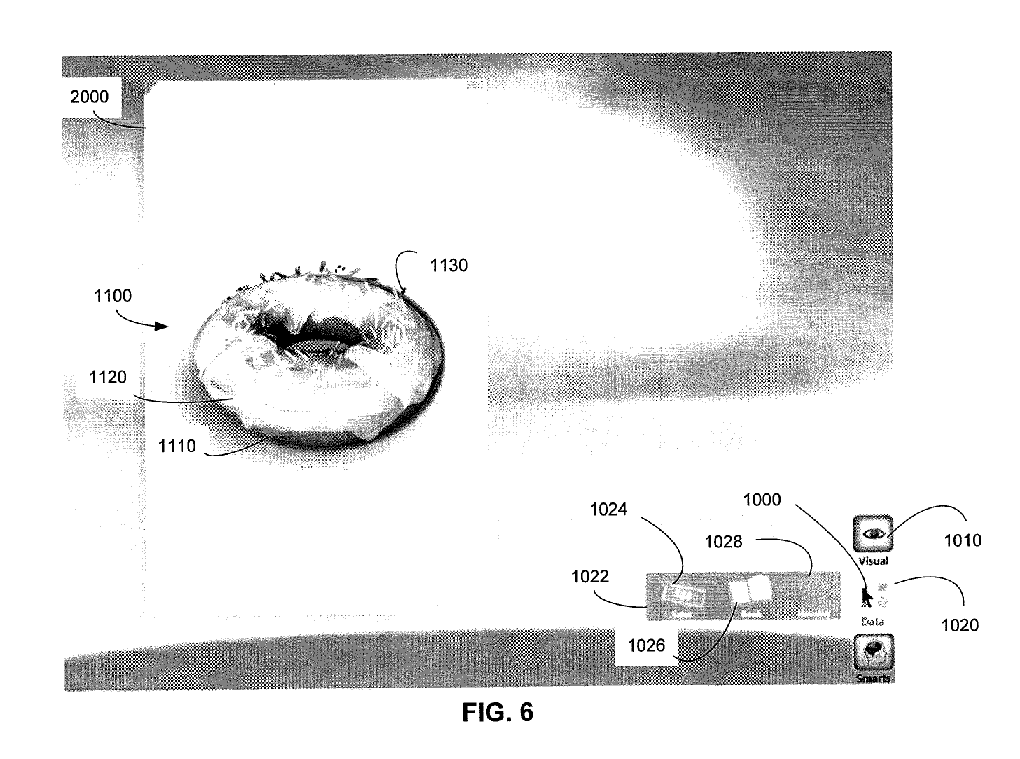

In FIG. 6, a generic graphical donut 1100 appears on the canvas 2000. The graphical donut 1100 includes three visual characteristics through which data may be represented, which are the dough 1110 of the donut, the icing 1120 to be disposed on the dough, and the sprinkles 1130 which are scattered on top of the icing. In addition, the user manipulates pointer 1000 to choose “Data” icon 1020 to initiate view of a subsequent interface 1022 through which a user may select dimensions of data for display. The interface 1022 includes three different data sets that may be displayed through, but without limitation, the graphical donut 1100. The data sets that may be displayed are sales data 1024, book data 1028 and housing data 1028. Although sales data 1024 is selected, it should be appreciated that suitable data set may be selected to be represented by visual characteristics of the chosen graphical object.

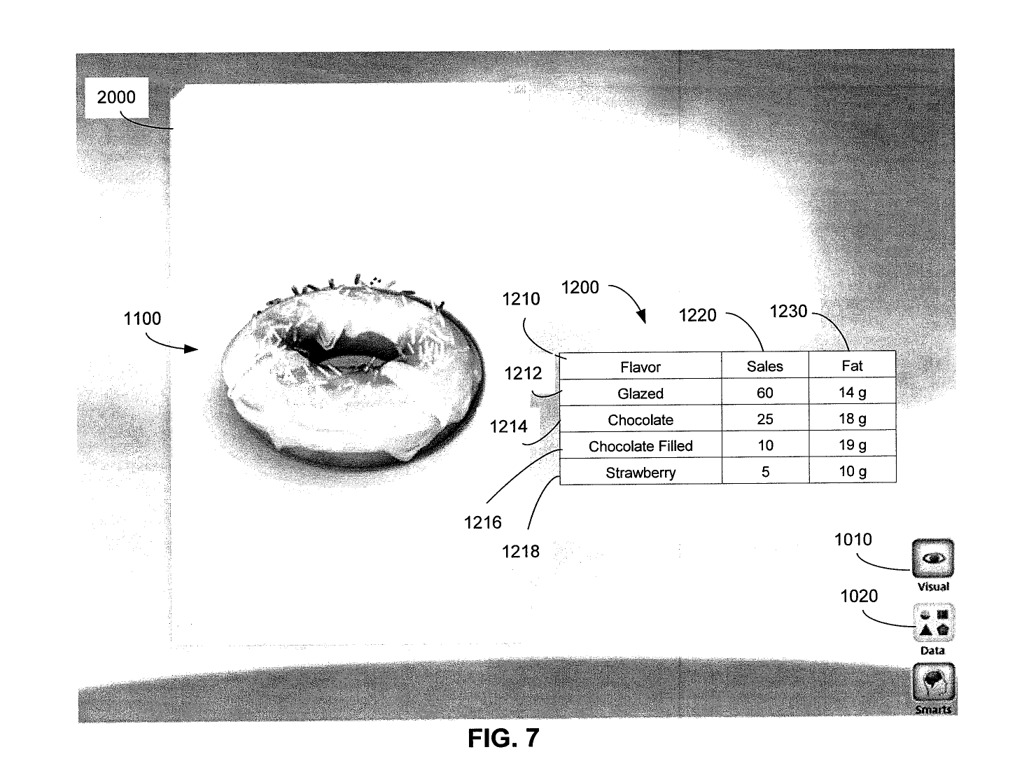

With the selection of sales data 1024, FIG. 7 illustrates a chart 1200 that depicts dimensions of a data set, for example, sales data 1220 reported from a donut shop of different flavors of donut 1210, each flavor of donut having a fat content 1230. As such, a listing of flavors of donuts 1210 and the respective sales 1220 and fat content 1230 for each flavor of donut is provided. As shown in the example, 60 million in revenue was reported from sales of the glazed donut having 14 g of fat, 25 million in revenue was reported from sales of the chocolate donut having 18 g of fat, 10 million in revenue was reported from sales of the chocolate filled donut having 19 g of fat, and 5 million in revenue was reported from sales of the strawberry donut having 10 g of fat. In the representative embodiment, the user selects the chart 1200 and applies the mapping of the data from the chart 1200 to the graphical donut 1100. A method for making such a selection may involve, for example, the user manipulating pointer 1000 to select the chart 1200 and dragging the data set over to the graphical donut 1100 for subsequent processing and visualization of data to occur by the system.

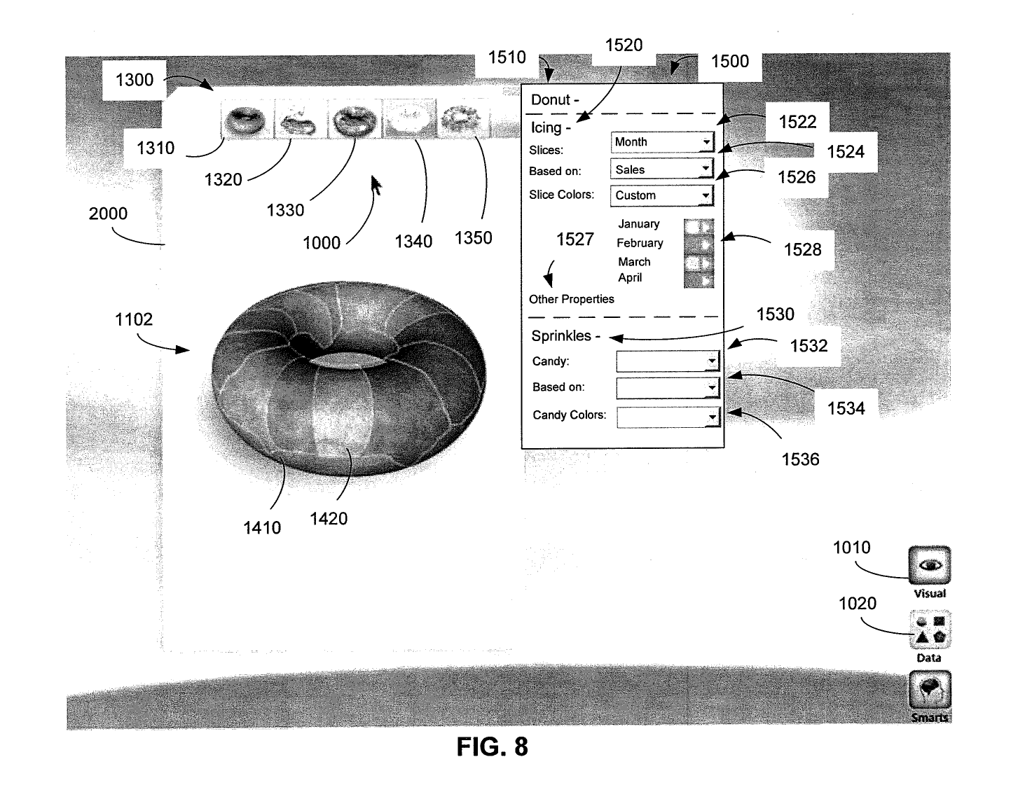

In the embodiment, the user interface is built based on metadata associated with the graphical donut 1100. As shown in FIG. 8, a number of parameters that describe a visual mapping between the data of sales reported and the graphical donut 1100 is displayed. Accordingly, based on the metadata incorporated in the graphical donut 1100, a modified graphical donut 1102 having sales data incorporated into the donut is presented. Graphical donut 1102 includes the dough 1410 and colors of icing 1420 segmented into twelve different regions. Each of the twelve regions corresponds to sales reported for each month of the year where the area occupied by each segment of icing 1420 is indicative of the amount of sales reported for that month. For example, when the area of a first segment of icing corresponding to a first month is depicted to be greater than the area of a second segment of icing corresponding to a second month, the sales reported at the end of the first month is interpreted in the sales representation to be greater than the sales reported at the end of the second month. Or, in another example, the color of icing displayed on a graphical donut may indicate a certain amount of sales. For instance, chocolate icing displayed for one segment may be indicative of greater sales reported for one particular month as compared with strawberry icing displayed for another segment, indicating sales reported for a different month.

In some embodiments, a number of proposed data visuals, through the same graphical object, are made available for the user to select. The proposed graphical donuts for representing the data are different in appearance as well as the number and type of visual characteristics to which data can be mapped. Accordingly, graphical donut 1102 is only one proposed visual of how the data set may be displayed. Indeed, a collection 1300 of proposed visuals 1310, 1320, 1330, 1340, 1350 are presented on the canvas 2000 for a user to choose. In the example shown in FIG. 8, graphical donut 1102 corresponds to selection of proposed visual 1340. As shown, the graphical box representing proposed visual 1340 is darkened and graphical donut 1102 is displayed on a main portion of canvas 2000.

In an embodiment, if proposed visual 1310 is selected, the graphical donut displayed in the center of the canvas 2000 would only include parameters associated with the dough of the donut; that is, dimensions of data would be presented on the donut with respect to the dough of the donut, without reference to other visual characteristics such as icing or sprinkles. In such a case, it may be desirable, for example, that sales data for an entire year be displayed, without a break down of variation within the year (e.g., by quarter, by sales event). In an example, the dough of the donut may take up a larger volume for greater amounts of sales reported, and conversely, the dough may be smaller in volume for a smaller amount of sales revenues reported.

For example, if proposed visual 1320 is selected, the graphical object displayed in the center of the canvas 2000 would include only portions of icing related to certain dimensions data that are to be presented, without showing the type of donut or sprinkles. For example, if it is desirable for sales data reported from only two quarters to be displayed, and not the entire year or sales from events during the year, then the icing graphic associated with only those two quarters will be presented.

Proposed visual 1330 enables data to be presented by all three major visual characteristics of the graphical donut; that is, the dough of the donut, icing and sprinkles together. In such a case, and without limitation, the dough of the donut may represent a total volume of sales reported at the end of a year, the icing may signify the amount of sales reported at the end of each quarter, and the sprinkles may indicate the occurrence of particular sales events that have contributed to overall sales.

Proposed visual 1340, which refers to the graphical donut 1102 of FIG. 8, combines aspects of proposed visualizations 1310 and 1320, permitting data to be displayed by the dough of the donut and the icing, yet without sprinkles. Accordingly, for example, total sales reported at the end of a year is presented by selecting the donut and sales reported at different points throughout the year (e.g., monthly, quarterly) is displayed by selecting certain types of icing to represent the break down of those reported sales.

Selecting proposed visual 1350, for example, would result in the graphical donut displayed on canvas 2000 to include data displayed by the dough of the donut and the sprinkles, yet without icing. In an example, data represented by the graphical donut would include annual sales reported, represented by the dough of the donut, and discrete sales events, represented by the sprinkles.

Indeed, proposed visuals may be selected as desired. For example, a proposed visual may be chosen according to whether how appealing or interesting the style of the visual appears. A proposed visual may also be selected based on its functionality, for example, the number of dimensions of data that can be displayed through the visual.

Also shown in FIG. 8, graphical manipulation tool 1500 illustrates an embodiment of how various parameters of visual characteristics of the graphical donut 1102 may be adjusted. For example, “Donut” adjustment box 1510 may be manipulated by a user for the system to modify parameters of data visualization through the donut itself and/or the data that is represented by the donut. “Icing” adjustment box 1520 may permit a user to provide input for the system to modify parameters of how the icing of the graphical object is used to display data and/or the data itself represented by the icing. “Sprinkles” adjustment box 1530 may also provide a user with the ability to provide input for the system to adjust parameters relating to a mapping between the graphical sprinkles and the data presented by the sprinkles.

As discussed previously, a user chooses the type of graphical object corresponding to particular dimensions of data for the system to render the data visual. In the representative embodiment, the user has selected a graphical donut to represent data regarding the revenue generated from donut sales reported over a year. While aspects of adjustment in the “Donut” adjustment box 1510 are not shown, the box 1510 may be opened to reveal features relating to how the graphical donut may be modified. For example, a different flavor donut may be selected to represent the data.

Given that graphical donut 1102 is displayed through selection of proposed visual 1340, features of the icing 1420 may be readily adjusted through modification of parameters in regions provided by “Icing” adjustment box 1520. “Icing” adjustment box 1520 includes a “Slices” region 1522 that provides a user with the ability to provide input for the system to adjust what dimensions of data are represented by the segments of icing depicted in the graphical donut. A “Based on” region 1524 permits a user to provide input as to what type of data the icing generally represents. The “Slice Colors” region 1526 allows a user to determine what colors will represent certain slices of icing through the visual rendering. An “Other Properties” region 1527 is further provided where more options for adjusting parameters of the icing will appear upon selection of this region.

In the example shown, the “Slices” region 1522 is currently given a “Month” setting in the drop down box and the “Based on” region 1524 is set to a “Sales” setting. The “Month” and “Sales” settings result in the icing 1420 of the graphical donut 1102 representing sales data reported by the business at the end of each month. In some cases, the “Slices” region 1522 may be given a different setting, for example, an annual or quarterly setting. Similarly, the “Based on” region 1524 may also be set to a different parameter besides sales, for example, inventory or organizational structure. In an example, the “Based on” region 1524 may be set to reveal sales of a particular donut (e.g., glazed, chocolate, chocolate-filled or strawberry), rather than sales of all donuts, so that it can be determined which donuts are more or less popular.

The “Slice Colors” region 1526 follows according to settings determined by the “Slices” region 1522 and the “Based on” region 1524, denoting the colors of each slice to be “Custom” selected. Hence, color selection region 1528 is provided adjacent to the “Slice Colors” region 1526 for a user to select what colors in the graphical rendering will denote which segments in the graphical donut 1102 representing months of the year. In some cases, the “Slice Colors” region 1526 may be given a setting other than “Custom,” for example, a “Default” setting where colors for each segment that represent months in the year may be automatically set to default colors determined by the system. Or, in another example, if the “Slices” region 1522 is set to an “Annual” setting (rather than by “Month”), then for sales data reported from the past few years, the color selection region 1528 may be reorganized so that selection of segments in the graphical donut 1102 represent past years as opposed to months.

Upon receiving user input for the above settings, the system retrieves the appropriate dimensions of data from the data set for mapping to the corresponding visual characteristic. Values of parameters that modify the appearance of each visual characteristic are set based on the values within each dimension. As a result, the graphical object is rendered according to the parameter values using known techniques for displaying objects with adjustable characteristics. In the example, for the icing visual characteristic, as the “Slices” region 1522 is set to “Month” and the “Based on” region 1524 is set to a “Sales,” the system acquires a dimension of data from the data set having to do with sales revenues reported for each month. Values of parameters corresponding to features of the visual characteristic that give rise to appearance are then set to match up with values of the dimension of sales revenues for each month.

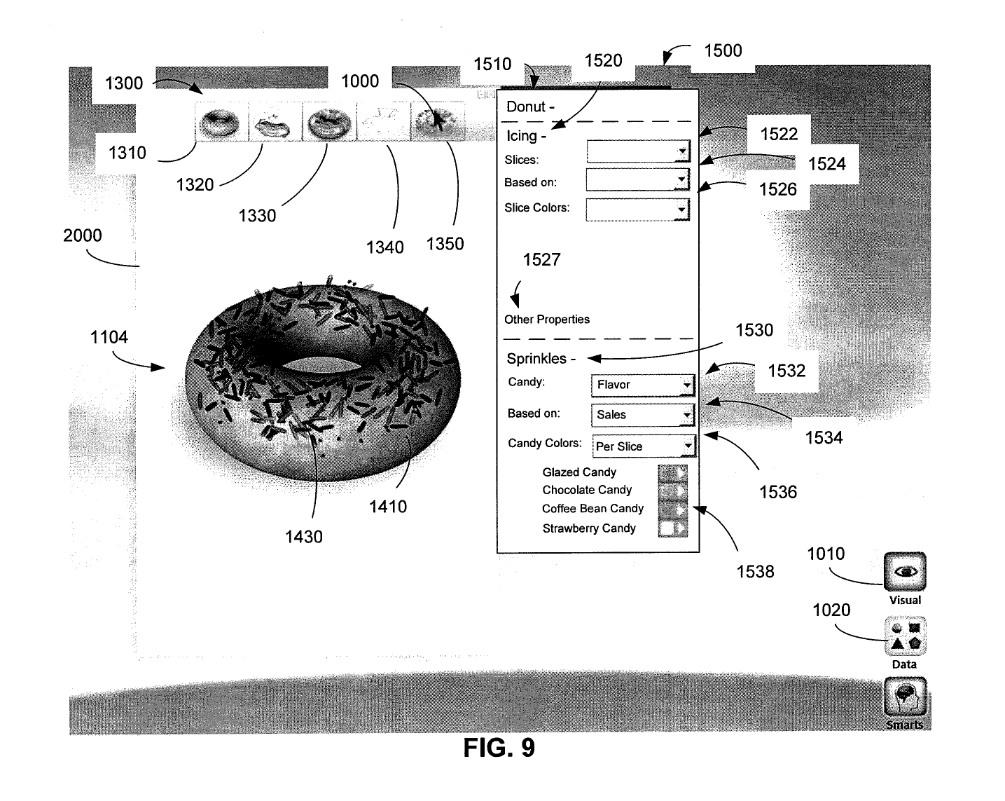

Continuing to refer to FIG. 8, currently selected proposed visualization 1340 does not provide for data to be represented by sprinkles, so no options are available for parameters within the “Sprinkles” adjustment box 1530 to be adjusted. Even so, various regions are still provided for viewing in the “Sprinkles” adjustment box 1530, including a “Candy” region 1532, a “Based on” region 1534, and a “Candy Colors” region 1536, explained in further detail below with respect to FIG. 9.

While in FIG. 8, graphical donut 1102 is displayed on canvas 2000 via selection of proposed visualization 1340, though, FIG. 9 depicts the result of selecting proposed visualization 1350. Hence, selection of proposed visualization 1350 results in a graphical donut 1104 without icing, yet having sprinkles, displayed on the canvas 2000. In an embodiment, proposed visualization 1350 is selected by the user, resulting in the box representing proposed visualization 1350 to be darkened and the transformation of graphical donut 1102 to currently displayed graphical donut 1104. As illustrated in FIG. 9, graphical donut 1104 includes the donut dough 1410 with sprinkles 1430 disposed atop the base, yet without the icing illustrated.

With the selection of proposed visualization 1350, graphical manipulation tool 1500 depicts some variation from that illustrated in FIG. 8. The proposed visualization 1350 does not provide for icing to be displayed in graphical object 1104, and so regions associated with “Icing” adjustment box 1520 are left blank. However, various regions are still provided for viewing in the “Icing” adjustment box 1520, including a “Slices” region 1522, a “Based on” region 1524 and a “Slice Colors” region 1526.

As further shown in FIG. 9, the “Candy” region 1532 of the “Sprinkles” adjustment box 1530 is currently set by the user to “Flavor,” that is, for the flavor of sprinkles 1430 of the graphical donut 1104 to be adjustable by the system. The “Based on” region 1534 is set by the user to “Sales,” indicating sprinkles 1430 rendered by the system to represent general sales reported by the company. The “Candy Colors” region 1536 is set through user input for the colors of candy to be depicted by the system “Per slice.” Color selection region 1538 is provided adjacent to the “Candy Colors” region 1536 to enable a user to choose what colors will correspond to which type of flavored sprinkles are rendered in the graphical donut 1104, such as for example, glazed candy, chocolate candy, coffee bean candy, or strawberry candy. In some embodiments, the appearance of a certain type of candy represents a sales event where a particular amount of revenue was collected. In an example not expressly illustrated or limited as such, glazed candy may represent sales events where more than 20 thousand in sales were accrued, chocolate candy may denote events where sales between 10 thousand and 20 thousand were collected, coffee bean candy may signify sales events of between 5 thousand and 10 thousand, and strawberry candy may represent sales events where less than 5 thousand in sales were collected.

As discussed above, prior to or after a data visualization has been rendered, various parameters of graphical objects and/or dimensions of a data set may be suitably adjusted, as desired. In some embodiments, visual characteristics of a graphical object may be appropriately changed to suit a preferred manner of data visualization. For example, visual characteristics of the graphical object may be resized according to certain ranges provided by the data set to be presented. Certain characteristics of the graphical object may be assigned to different colors, or transformed altogether, according to desired parameters for the data visualization. In some instances, visual characteristics may be subject to constraints where certain features of the appearance of a visual characteristic is limited by the constraints set on parameters of the visual characteristic. For example, to reduce computational expense, a constraint on a visual characteristic to limit the representation of data values within a tolerance of 1% precision can be set. In some embodiments, rendering of a data visual involves replicating or subdividing at least a portion of a visual characteristic multiple times. For example, in binding data to a visual characteristic, visual elements of the visual characteristic, such as bars, points or pie segments, may be suitably replicated or subdivided. The ability for the system to replicate or subdivide particular visual elements of a visual characteristic may further be subject to constraints. For example, one constraint may be for a bar of a visual characteristic to be restricted to no more than 10 subdivisions. Or, another constraint may be for angles of a pie segment to be restricted to no less than 5 degrees.

In some cases, the data itself may be manipulated, resulting in alterations of visual characteristics in the graphical object. For example, when dimensions of data are added, removed and/or subject to filtering, the visualization of data through the graphical object may be appropriately modified according to how the data is adjusted.

In the example provided of the graphical donut, the toroidal shape of the donut provides for sales data to be displayed according to sales reported during certain periods of a fiscal year. Thus, while not being limited as such, the donut is partitioned into segments in accordance with sales reported at various points in the year. Alternatively, the ability for sprinkles to be scattered about any location on the surface of the donut can map to data that records the occurrence of certain sales occasions during the year. It should be understood that the above description provides only an exemplary embodiment of a data visual. Indeed, visual characteristics of a graphical object may have parameters to suit any desirable mapping of dimensions in a data set to the visual characteristics.

While parameters of visual characteristics in a graphical object may be appropriately varied, dimensions of data and/or visual characteristics themselves may be subject to certain filters and/or constraints. When a filter or constraint is applied to the data visualization, a modified data visual is generated in accordance with the filter or constraint. For example, a parameter that specifies a broad range under which dimensions of data fall may provide for a visualization of a large number of dimensions of a data set. However, applying a filter that changes the parameter to a narrower range under which dimensions of data fall will result in a modified visualization of a smaller number of dimensions of data to be represented. Similarly, values of parameters that define the appearance of certain visual characteristics may be set according to one or more constraints. As a result, only certain values within a dimension of data may be displayed through the visual characteristics through which the constraint(s) are applied.

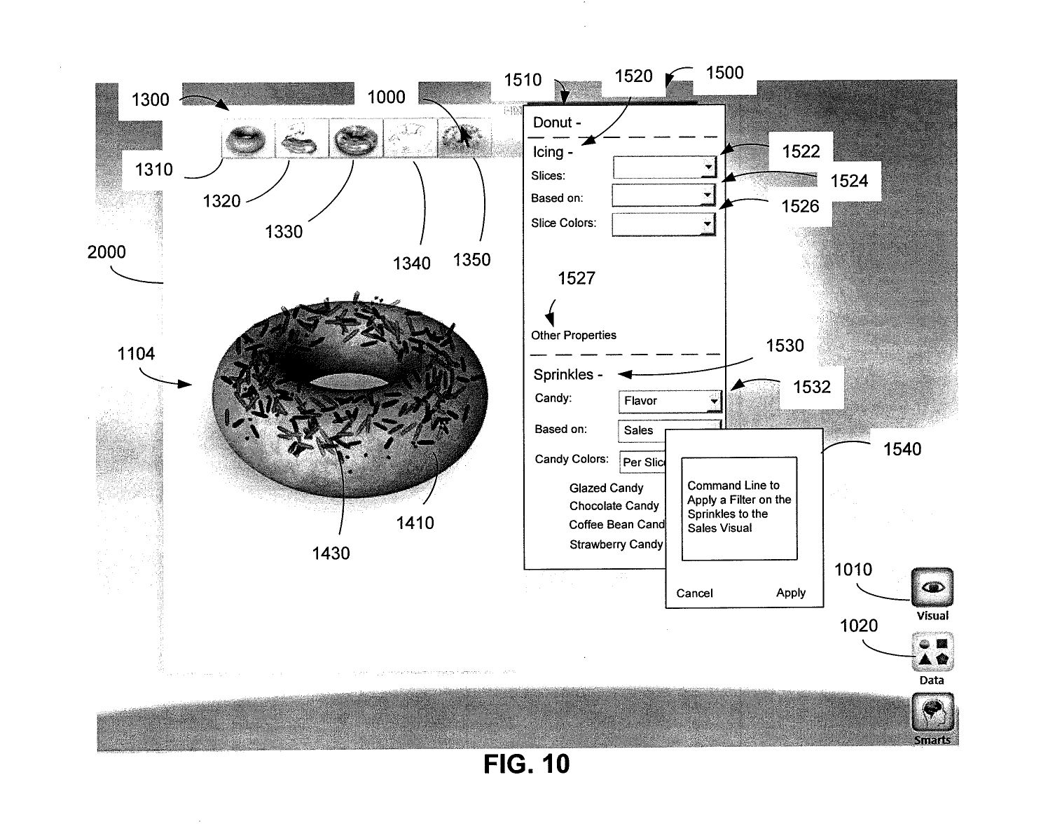

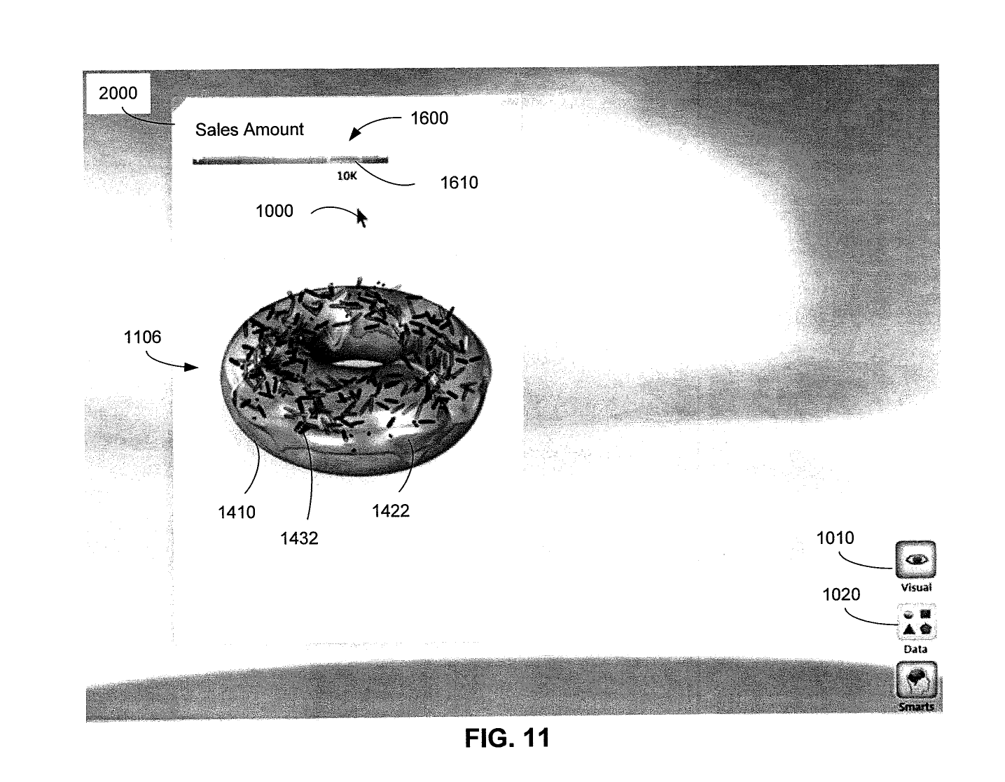

In the above example of the graphical donut for visualizing sales data, FIG. 10 depicts a filter command box 1540 that provides the ability for an added filter to be applied to the data visualization. The filter command box 1540 applies a filter to the sprinkles 1430 of the sales data visualization. Once applied, FIG. 11 illustrates a graphical donut 1106 having a donut base 1410, icing 1422 and sprinkles 1432 where one or more visual characteristics are linked to the applied filter. In particular, the sprinkles 1432 are mapped to a set of data that is filtered according to setting a sliding scale 1600 that refers to sales recorded within a certain amount range. A highlighted range 1610 shown along sliding scale 1600 is provided as a filter for the data represented by the graphical donut. In this example, the number of sales events where the amount collected falls within the highlighted range 1610 is represented by the number of sprinkles on the graphical donut. As shown in FIG. 11, for graphical donut 1106, sales events where the amount collected was within a range of about $10,000+/−$1,000 are represented as sprinkles 1432.

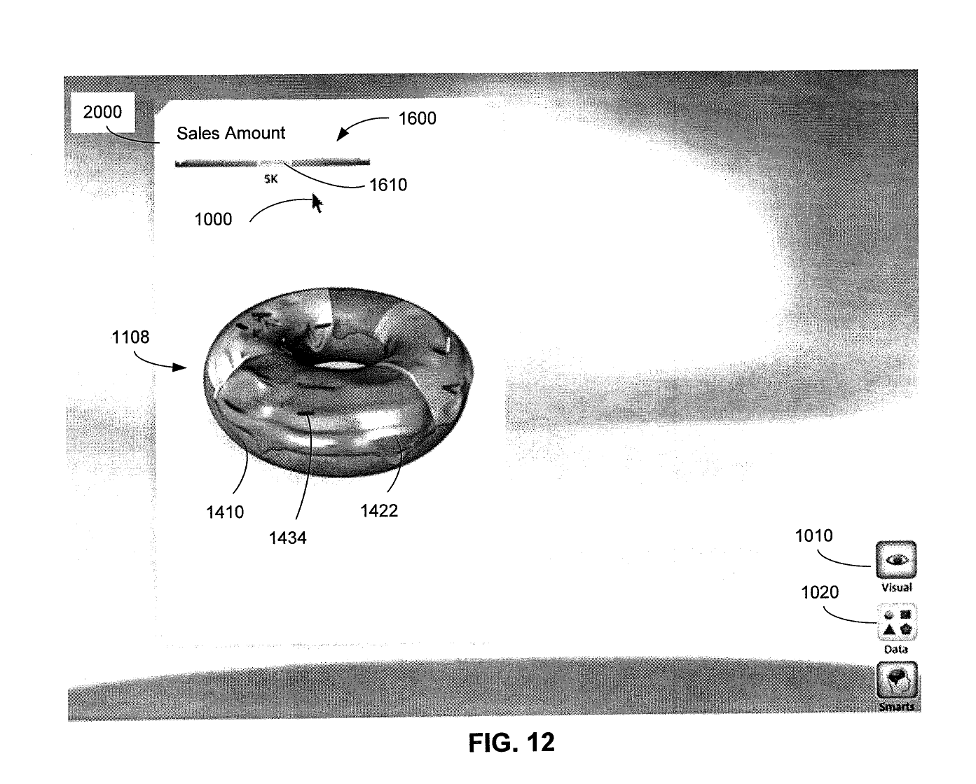

However, turning toward FIG. 12, the highlighted range 1610 that centered around $10,000 is moved to a range of about $5,000+/−$1,000. Accordingly, the graphical donut 1106 of FIG. 11 is transformed to the graphical donut 1108 of FIG. 12 where only sales events that qualify within the range of $5,000+/−$1,000 are displayed, as sprinkles 1434. As depicted, the amount of sprinkles 1434 shown is substantially less than the amount of sprinkles 1432, denoting that there were substantially more sales events with amounts collected in the $10,000+/−$1,000 range as compared with sales events with amounts collected in the $5,000+/−$1,000 range. It should be appreciated that depiction of applied filters shown in FIGS. 11 and 12 are provided by way of example and that any suitable set of filters or constraints can be applied to a data visualization the visualization may dynamically be adjusted through any appropriate user interface.

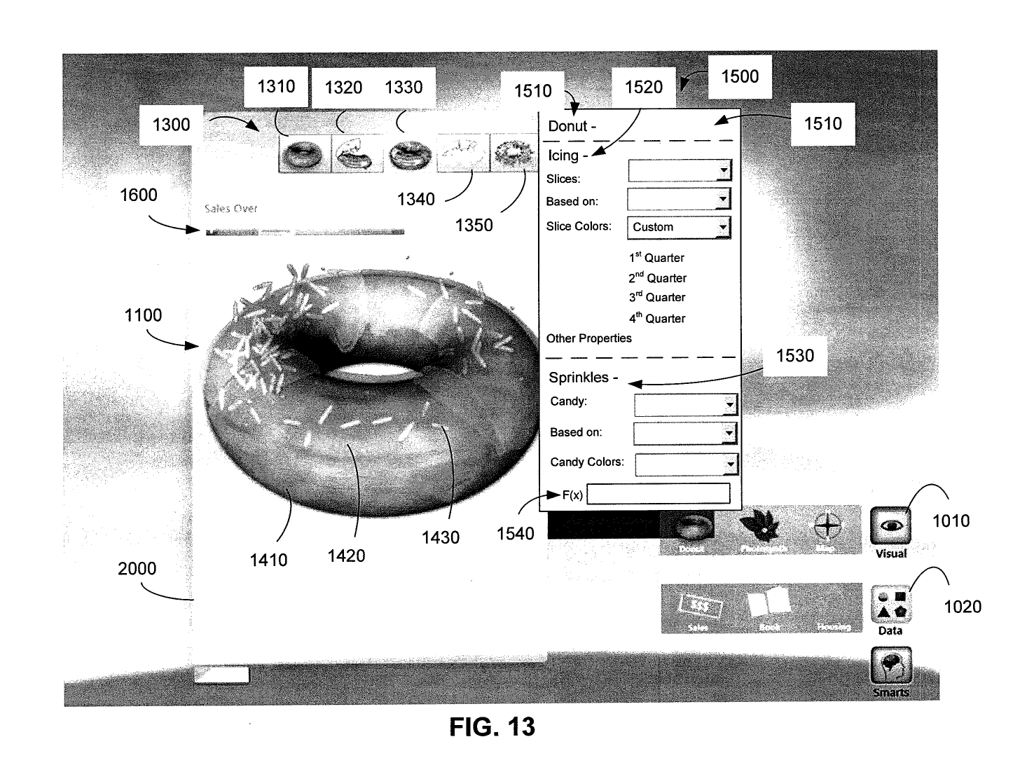

The user interface of FIG. 13 generally depicts each of the features described above with respect to data visualization through the graphical donut. A graphical object may be chosen via selection of “Visual” icon 1010; and a data set may be chosen to be presented through the graphical object through selection of “Data” icon 1020. Canvas 2000 may display the graphical object 1100, a number of proposed visualizations 1300 as well as filters or constraints 1600 that the visual characteristics of the graphical object 1100 and/or the data itself may be subject to. Further, graphical manipulation tool 1500 may provide for parameters of visual characteristics of the graphical object to be modified as desired.

Metadata may be associated to visual characteristics of graphical objects to define parameters through which data may be bound to the visual characteristics. Such metadata provide information for how binding or mapping of dimensions of data to visual characteristics may occur. For example, the parameters that define how visual characteristics may receive data to be represented through the visual characteristics may include metadata that inform how the visual characteristics may be adjusted or changed (e.g., transformed, scaled, re-shaped, colored, etc.).

In the example above, to display how much revenue was collected during a certain quarter, the color of icing would identify the particular quarter of interest and the volume of icing would represent the amount of revenue collected for that quarter. In an inverse example, for visualizing the same information, a different set of parameters could be defined, such as the color of the icing to represent the amount of revenue collected for that quarter and the volume and location of icing specifying the particular quarter of interest. It can be appreciated that visual characteristics of graphical objects may be adjusted in accordance with any suitable parameters so as to accurately and effectively represent the data.

The parameters that define how data may be bound to visual characteristics may include metadata that provides constraints as to what degree the visual characteristic(s) may be manipulated. That is, there may be aesthetic or proportional aspects of visual characteristics of the graphical object that limit certain dimensions of data from being displayed. Indeed, for some embodiments, certain data structures may be outside the scope of what a graphical object may be able to represent.

Further, metadata may be associated with the data set itself to define parameters that describe how dimensions of data may map to certain graphical objects. For example, different data sets may have intrinsic differences. In an embodiment, a data set may be represented as a continuous variation, such as through a gradient depicted through a visual characteristic. Alternatively, a data set may be displayed as a set of enumerable discrete values through, for example, discrete features of a visual characteristic. Metadata may indicate whether the data set includes a particular range of data values, or for example, geometric implications such as locations, structural features and/or coordinates. Metadata may describe dimensions of data having relationships within sets, for example, a listing of peer values or alternatives. In some cases, certain dimensions of data in a data set may be discarded as outliers, and not included in the visualization of the data set. Dimensions of data may also be described by metadata as to whether the data is sampleable, quantizable and/or smoothable in nature.

A system that produces a visualization of dimensions of data by mapping the dimensions of data to an independently created graphical object may generate the data visual through any series of steps. In an embodiment for generating the data visual, a system analyzes the metadata and/or parameters associated with visual characteristics of the graphical object. The system also analyzes metadata and/or parameters intrinsic to the data set itself. The system then identifies certain visual characteristics of the graphical object and the ability for certain types and dimensions of data map to one or more visual characteristics. Schemes for transforming dimensions of the data set to suit the process of mapping the visual characteristics to the dimensions of data are also ascertained.

Further, a number of proposed visualizations for binding dimensions of data in the data set to visual characteristics of the graphical object may be presented. Accordingly, a user may select which of the proposed visualizations of the data is preferred to suit the user's interests (e.g., understanding the data better, presenting to the data to a group, etc.).

Additionally, and as described above, parameters of the visual characteristics as well as the dimensions of data may be appropriately manipulated, as desired, to yield modified data visualizations.

Having thus described several aspects of at least one embodiment of this invention, it is to be appreciated that alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, digitizing tablets, and touch-responsive display screen, such as direct-interaction displays, multi-touch displays that respond to two or more fingers on the screen at the same time. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer-readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that, when executed, perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the dimensions listed thereafter and equivalents thereof as well as additional dimensions.

1. A method of using at least one processor to present data, the method comprising:
selecting a graphical object having a visual characteristic;
mapping a dimension of a data set to the visual characteristic of the graphical object, the visual characteristic having an appearance based on a value of a graphical parameter; and
rendering a data visual of at least a portion of the data set through the graphical object according to the mapping of the dimension of the data set to the visual characteristic such that a value in the dimension of the data set corresponds to the value of the graphical parameter.

2. The method of claim 1, wherein the graphical parameter object is created using a graphical manipulation tool.

3. The method of claim 1, wherein the visual characteristic of the graphical object includes at least one of color, a plurality of segments, or a plurality of boundaries that maps to the dimension of the data set.

4. The method of claim 1, further comprising removing one or more outliers from the data set.

5. The method of claim 1, further comprising modifying the visual characteristic of the graphical object and rendering a modified data visual of the portion of the data set through the modified graphical object.

6. The method of claim 1, further comprising modifying the dimension of the data set and rendering a modified data visual of the portion of the data set through the modified graphical object.

7. The method of claim 1, wherein the graphical parameter corresponding to the visual characteristic is subject to a constraint of the visual characteristic of the graphical object.

8. The method of claim 1, further comprising automatically rendering a plurality of data visuals of the portion of the data set through the graphical object from which a user may select.

9. The method of claim 1, further comprising generating metadata to define how the visual characteristic of the graphical object can be varied.

10. The method of claim 1, wherein the mapping of the dimension of the data set to the visual characteristic of the graphical object comprises mapping an enumerable set of values from the dimension of the data set with the value of the graphical parameter. includes a continuous values

11. The method of claim 1, wherein selecting the graphical object occurs based on a type of data in the data set and the visual characteristic.

12. The method of claim 1, wherein the graphical object includes a plurality of visual characteristics.

13. The method of claim 1, wherein rendering the data visual through the graphical object according to the mapping of the dimension of the data set to the visual characteristic comprises replicating at least a portion of the visual characteristic multiple times within the graphical object.

14. The method of claim 1, wherein rendering the data visual through the graphical object according to the mapping of the dimension of the data set to the visual characteristic comprises subdividing at least a portion of the visual characteristic multiple times within the graphical object.

15. At least one non-transitory computer-readable storage medium comprising computer-executable instructions that, when executed by at least one processor, perform a method of visualizing data, the method comprising:
importing a graphical object having a plurality of visual characteristics;
mapping each of a plurality of dimensions of a data set to a visual characteristic of the plurality of visual characteristics; and
rendering a data visual of the data set through the graphical object.

16. The computer-readable storage medium of claim 15, wherein the graphical object supports visualization of a range of values from the plurality of dimensions of the data set.

17. The computer-readable storage medium of claim 15, further comprising removing one or more outliers from the data set.

18. The computer-readable storage medium of claim 15, further comprising modifying at least one of a visual characteristic of the graphical object or at least one of a dimension of the data set and rendering a modified data visual of the data set through the graphical object.

19. The computer-readable storage medium of claim 15, further comprising automatically rendering a plurality of data visuals of the data set through the graphical object from which a user may select.

20. A method of operating a computing device to create an interactive graphical representation of data, the method comprising:
selecting a graphical object having a plurality of visual characteristics with graphical parameters for visualizing data;
receiving user input selecting a plurality of dimensions of a data set to be mapped to the plurality of visual characteristics of the graphical object and represented based on the graphical parameters;
displaying a data visual of the plurality of dimensions of the data set through the plurality of visual characteristics of the graphical object; and
applying a constraint to a visual characteristic of the plurality of visual characteristics for visualizing the plurality of dimensions of the data set and displaying a subsequent data visual of the plurality of dimensions of the data set based on the applied constraint.
